(19) United States
(12) Patent Application Publication
(10) Pub. No.: US 2009/0121985 A1
(43) Pub. Date: May 14, 2009

(54) Organic light emitting display and driving method thereof

(76) Inventors: Ki-Nyeng Kang, Suwon-si (KR); Hae-Kwan Seo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/215,454

(22) Filed: Jun. 26, 2008

(30) Foreign Application Priority Data
Nov. 8, 2007 (KR) 10-2007-0113811

(51) Int. Cl. G09G 3/32; G09G 3/36

(52) U.S. Cl. 345/82; 345/87; 345/92

(57) ABSTRACT

A translucent organic light emitting display having high image quality is disclosed. The display includes a substantially transparent organic light emitting display (OLED) panel, and a liquid crystal display (LCD) panel. The pixels in the OLED panel overlap the pixels in the LCD panel. The LCD panel pixels are configured to be opaque when the corresponding pixels of the OLED display do not emit light.

### CROSS-REFERENCE TO RELATED APPLICATION

This application claims priority to and the benefit of Korean Patent Application No. 10-2007-0113811 filed on Nov. 8, 2007 in the Korean Intellectual Property Office, the entire content of which is incorporated herein by reference.

### BACKGROUND

1. Field

The field relates to an organic light emitting display and a driving method thereof, and more particularly to an organic light emitting display with improved image quality, and a driving method thereof.

2. Discussion of Related Technology

In recent years, a variety of flat panel displays of reduced weight and volume when compared to a cathode ray tube have been developed and commercialized. A flat panel display may take the form of a liquid crystal display (LCD), a field emission display (FED), a plasma display panel (PDP), an organic light emitting display (OLED), etc.

Among the flat panel displays, the organic light emitting display uses an organic light emitting diode to display an image, the organic light emitting diode generating the light by means of the recombination of electrons and holes. Such an organic light emitting display has an advantage that it has a rapid response time and also it is driven with low power consumption.

Each of the pixels in the organic light emitting display includes at least one thin film transistor. A method for forming a transparent thin film transistor in each of the pixels is very desirable. A transparent panel including the transparent thin film transistor may be used in the field of various applications.

However, it is difficult to display a translucent image with good image quality with the transparent panel. This occurs because when an image is displayed with the transparent panel, the background seen through the regions displaying a black color.

### SUMMARY OF CERTAIN INVENTIVE ASPECTS

One aspect is an organic light emitting display, including a transparent panel, with a plurality of first pixels, each first pixel including an organic light emitting diode and one or more transistors connected with the organic light emitting diode, and a semiconductor layer formed of transparent materials. The display also has a liquid crystal panel having a plurality of second pixels, each of the second pixels disposed to overlap one of the first pixels, a scan driver configured to drive a plurality of scan lines, where the scan lines are connected with the first pixels and the second pixels, and corresponding first and second pixels are connected to the same scan line. The display also has a first data driver configured to supply a data signal to first data lines, where the first data lines are connected with the first pixels, a second data driver configured to supply a first data signal or a second data signal to second data lines, where the second data lines are connected with the second pixels, and a timing controller configured to control the scan driver, the first data driver and the second data driver.

Another aspect is a method of driving an organic light emitting display including a transparent panel having a plurality of first pixels, each of the first pixels including an organic light emitting diode, transistors connected with the organic light emitting diode, and a semiconductor layer formed of transparent materials. The organic light emitting display also includes a liquid crystal panel having second pixels, each of the second pixels disposed to overlap a corresponding one of the first pixels. The method including displaying an image by supplying a data signal to the first pixels, and controlling the second pixels to transmit the light generated in the first pixels or to display a black level.

Another aspect is an organic light emitting display, including a transparent panel, having a plurality of first pixels, each first pixel including an organic light emitting diode, and a liquid crystal panel having a plurality of second pixels, each of the second pixels corresponding to one of the first pixels, such that the corresponding pixels substantially overlap, where when a first pixel does not emit light, the corresponding one of the plurality of second pixels is substantially opaque.

### BRIEF DESCRIPTION OF THE DRAWINGS

These and/or other aspects and features will become apparent and more readily appreciated from the following description of certain embodiments, taken in conjunction with the accompanying drawings of which:

FIG. 1 is a diagram showing an organic light emitting display according to one exemplary embodiment.

FIG. 2 is a block diagram showing a transparent panel shown in FIG. 1.

FIG. 3 is a block diagram showing a liquid crystal panel shown in FIG. 1.

FIG. 4 is a circuit view showing a first pixel and a second pixel shown in FIGS. 2 and 3.

### DETAILED DESCRIPTION OF CERTAIN INVENTIVE EMBODIMENTS

Hereinafter, certain exemplary embodiments will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention may be omitted for brevity. Also, like reference numerals generally refer to like elements throughout.

FIG. 1 is a diagram showing an organic light emitting display according to one exemplary embodiment.

Referring to FIG. 1, the organic light emitting display includes a transparent panel 100 in which organic light emitting diodes are disposed in a matrix; and a liquid crystal panel 200 having a liquid crystal layer.

The transparent panel 100 includes at least one or more transparent thin film transistors connected with each of the organic light emitting diodes. One organic light emitting diode and the transparent thin film transistors connected with the one organic light emitting diode form one pixel (a first pixel) when an image is not displayed in the transparent panel 100, one side of the transparent panel 100 may be viewed from the other side through the transparent panel 100. And, when an image is displayed in the transparent panel 100, the image may be viewed from either side of the transparent panel 100.

The liquid crystal panel 200 may be disposed adjacent to the transparent panel 100. The liquid crystal panel 200 includes liquid crystal pixels (second pixels) that are disposed to be substantially overlapping each of the first pixels in the transparent panel 100. The second pixels take on a dark level and therefore an opaque quality when a dark color is displayed in corresponding first pixels overlapping the second pixels. When a black color is not displayed in the corresponding first pixels, the second pixels are substantially transparent. Accordingly, the second pixels of the liquid crystal panel 200 are used to display a black color such that the quality of the black color displayed by the combination of the liquid crystal panel 200 and the transparent panel 100 is better than that displayed by the transparent panel 100 alone.

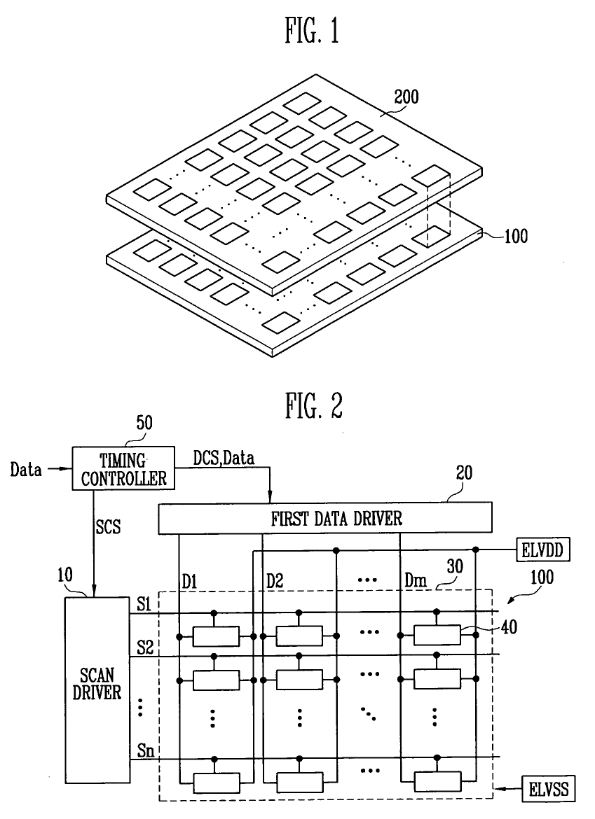

FIG. 2 is a block diagram showing an embodiment of a transparent panel shown in FIG. 1. In FIG. 2, a data driver 20, a scan driver 10 and a timing controller 50 are included with the transparent panel 100, or disposed outside the transparent panel 100.

The transparent panel 100 includes a plurality of pixels 40 connected with scan lines (S1 to Sn) and data lines (D1 to Dm) (or, first data lines). And, the scan lines (S1 to Sn) are connected with and driven by the scan driver 10, and the data lines (D1 to Dm) are connected with and driven by the data driver 20. Also, the scan driver 10 and the data driver 20 are connected with the timing controller 50 and are controlled by the timing controller 50.

The pixel unit 30 receives a first power source (ELVDD) and a second power source (ELVSS). Each of the first pixels 40 receives a data signal when a scan signal is supplied to the first pixels 40, and generates light with luminance corresponding to the received data signal.

For this purpose, at least one transistor is formed in each of the pixels 40. The transistor includes a gate electrode, a semiconductor layer, a source electrode and a drain electrode.

The gate electrode, the source electrode and the drain electrode are formed of transparent materials, for example, ITO (indium tin oxide), IZO (indium zinc oxide), ITZO (indium tin zinc oxide), ICO (Indium Cesium Oxide), etc.

The semiconductor layer forms a channel which is a path for carriers when a drive voltage is applied to the gate electrode. The semiconductor layer is formed of transparent materials. For example, the semiconductor layer may be formed of at least one selected from the group consisting of oxides such as ZnO, ZnSnO, CdSnO, GaSnO, TISnO, InGaZnO, CuAlO, SrCuO and LaCuOS; nitrides such as GaN, InGaN, AlGaN and InGaAlN; and carbides such as SiC and diamond. Other materials may also be used.

The thin film transistor in the first pixels 40 is formed of transparent materials. Accordingly, if an image is not displayed in the organic light emitting display, because the transparent panel 100 is substantially transparent, that which is behind the transparent panel 100 is visible through it. Therefore the black of the transparent panel 100 is not black, but rather transparent. The organic light emitting display including the transparent panel 100 may be used in the field of various applications. For example, when the organic light emitting display is installed in refrigerators and the like, articles in the refrigerators may be observed through the organic light emitting display, and various information on the observed articles may be displayed by the organic light emitting display.

The scan driver 10 supplies a scan signal to the scan lines. (S1 to Sn). If the scan signal is supplied to the scan lines (S1 to Sn), the first pixels 40 are selected in the line to which the scan signal is currently supplied. The selected first pixels 40 receive a data signal from the data lines (D1 to Dm).

The data driver 20 generates data signals using a data (Data), and supplies the generated data signals to the data lines (D1 to Dm) whenever a scan signal is supplied to the data driver 20. Then, the data signals are supplied to the first pixels 40 selected by the scan signal.

The timing controller 50 generates a data drive control signal (DCS) and a scan drive control signal (SCS) according to synchronizing signals received from another circuit. The data drive control signal (DCS) generated in the timing controller 50 is supplied to the data driver 20, and the scan drive control signal (SCS) is supplied to the scan driver 10.

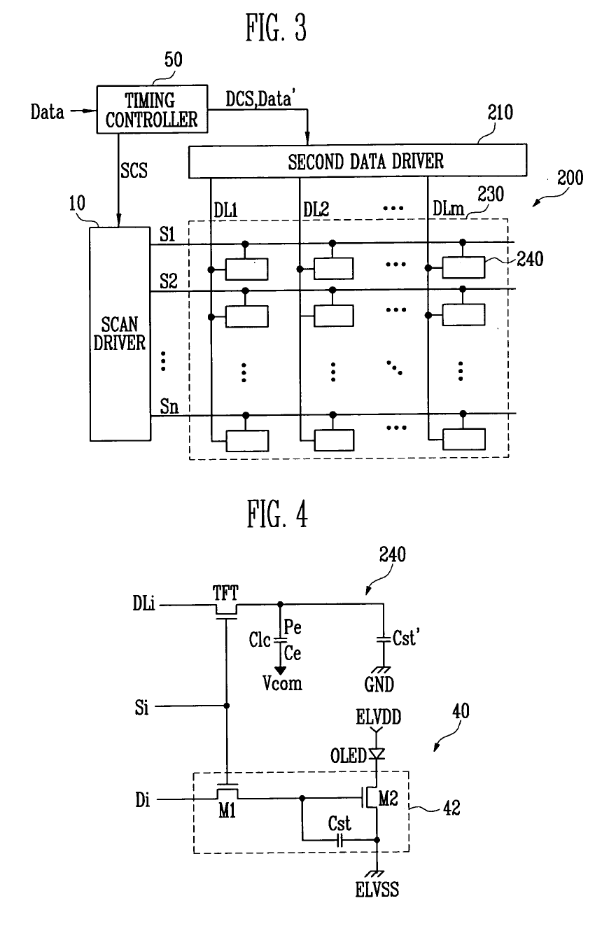

FIG. 3 is a block diagram showing a liquid crystal panel as shown in FIG. 1. In FIG. 3, similar parts to those in FIG. 2 generally have the same reference numerals, and descriptions of the similar parts are minimal or omitted. In FIG. 3, the scan driver 10 and the timing controller 50 are used with transparent panel 100. A data driver 210 (or, a second data driver) is used separately from the data driver 20 (or, a first data driver) of the transparent panel 100.

The liquid crystal panel 200 includes a plurality of liquid crystal pixels 240 connected with scan lines (S1 to Sn) and data lines (DL1 to DLm) (or, second data lines). And, the scan lines (S1 to Sn) are connected with the scan driver 10, and the data lines (DL1 to DLm) are connected with the data driver 210.

The pixel unit 230 includes liquid crystal pixels (or, second pixels) 240 disposed in a matrix. Here, a certain second pixel 240 connected with an i^{th} (i is integer) scan line (Si) and an i^{th} data line (DLi) is disposed to be overlapped with a corresponding first pixel 40 connected with the i^{th} scan line (Si) and the i^{th} data line (Di). The second pixels 240 receive a first data signal or a second data signal from the data line (DL), and control the transmission of the light from the corresponding first pixel 40 according to the received data signal.

For example, the liquid crystal pixel 240 receiving a first data signal transmits the light from the corresponding first pixel 40. In this case, the transparent panel 100 is observed through the liquid crystal panel 200. And, the liquid crystal pixel 240 receiving a second data signal displays a black level and becomes substantially opaque.

The scan driver 10 sequentially supplies a scan signal to the scan lines (S1 to Sn). If the scan signal is sequentially supplied to the scan lines (S1 to Sn), the second pixels 240 are sequentially selected by line. The selected second pixels 240 receive a data signal from the data lines (DL1 to DLm).

The data driver 210 generates first and second data signals using data (Data′) (or, a second data) supplied from the timing controller 50. Here, the timing controller 50 generates a data (Data′) to be supplied to the data driver 210 by using data (Data) supplied from another circuit.

The timing controller 50 supplies data (Data′) so that the first data signal can be supplied to a certain second pixel 240 overlapping a corresponding first pixel 40 if the data (Data) corresponding to a grey level other than black is supplied to the corresponding first pixel 40. Also, the timing controller 50 supplies data (Data′) so that the second data signal is supplied to the certain second pixel 240 if the data (Data) corresponding to the black grey level is supplied to the corresponding first pixel 40.

That is to say, the timing controller 50 supplies the second data signal so that the black grey level can be displayed in the certain second pixel 240 overlapping the corresponding first pixel 40 if the black grey level is displayed in the certain first pixel 40. Accordingly, if an image is displayed in the organic light emitting display, the black grey level is generated in the liquid crystal panel 200. And, the other grey levels are generated in the transparent panel 100.

The timing controller 50 may supply a first data signal to all of the second pixels 240 if an image is not displayed in the transparent panel 100. Then, the organic light emitting display is substantially transparent.

The timing controller 50 supplies a data drive control signal (DCS) to the data driver 210, and supplies a scan drive control signal (SCS) to the scan driver 10.

FIG. 4 is a circuit view showing an embodiment of the first pixel and the second pixel. For convenience’ sake, FIG. 4 shows a certain first pixel 40 connected to an i^{th} scan line (Si) and an i^{th} data line (Di), and a corresponding second pixel 240 disposed to be overlapped with the first pixel 40.

Referring to FIG. 4, the first pixel 40 includes an organic light emitting diode (OLED); and a pixel circuit 42 connected with the data line (Di) and the scan line (Si) to control the organic light emitting diode (OLED).

An anode electrode of the organic light emitting diode (OLED) is connected with a first power source (ELVDD), and a cathode electrode of the organic light emitting diode (OLED) is connected with the pixel circuit 42. The organic light emitting diode (OLED) has an electric current according to the control of the driver transistor (M2) in the pixel circuit 42. Therefore, the organic light emitting diode (OLED) generates the light according to the drive transistor (M2).

The pixel circuit 42 receives a data signal from data line (Di) when a scan signal is supplied to the scan line (Si). And, the pixel circuit 42 controls an electric current from the organic light emitting diode (OLED), the electric current corresponding to the data signal. The pixel circuit 42 includes a second transistor (M2) coupled between the organic light emitting diode (OLED) and the second power source (ELVSS); a first transistor (M1) coupled to the second transistor (M2), the data line (Di) and the scan line (Si); and a storage capacitor (Cst) coupled between a gate electrode and a first electrode of the second transistor (M2).

A gate electrode of the first transistor (M1) is connected to the scan line (Si), and a second electrode of the first transistor (M1) is connected to the data line (Di). And, a first electrode of the first transistor (M1) is connected to the gate electrode of the second transistor (M2). Here, the first electrode is either a source electrode or a drain electrode, and the second electrode is the other of the source electrode and the drain electrode. For example, if the first electrode is the source electrode, the second electrode is the drain electrode.

When a scan signal (a high level voltage) is supplied from the scan line (Si), the first transistor (M1) is turned on to supply a data signal, from the data line (Di), to a storage capacitor (Cst). At this time, the storage capacitor (Cst) is charged with a voltage corresponding to the data signal.

The gate electrode of the second transistor (M2) is connected to one terminal of the storage capacitor (Cst), and the first electrode of the second transistor (M2) is connected to the storage capacitor (Cst) and the second power source (ELVSS). And, the second electrode of the second transistor (M2) is connected to a cathode electrode of the organic light emitting diode (OLED). The second transistor (M2) controls current according to a voltage level stored in the storage capacitor (Cst), the controlled current flowing from the first power source (ELVDD) to the second power source (ELVSS) through the organic light emitting diode (OLED). At this time, the organic light emitting diode (OLED) generates the light corresponding to the current.

Transistors (M1, M2) in the pixel circuit 42 are NMOS type. In some embodiments, the circuit configuration of the pixel circuit 42 may be modified to use other types of transistors to control a current capacity that flows in the organic light emitting diode (OLED). For example PMOS type transistors can be used. In embodiments using PMOS type transistors, the organic light emitting diode (OLED) may be disposed between the second transistor (M2) and the second power source (ELVSS).

Referring to FIG. 4 again, the second pixel 240 includes a thin film transistor (TFT) disposed between the scan line (Si) and the data line (DLi); and a liquid crystal capacitor (Clc) and a storage capacitor (Cst′) coupled to the thin film transistor (TFT). Here, the liquid crystal capacitor (Clc) represents a liquid crystal pixel between a pixel electrode (Pe) connected with a first electrode of the thin film transistor and a common electrode (Ce). And, the pixel electrode (Pe) and the common electrode (Ce) are formed of transparent materials, for example, ITO, IZO, ITZO, ICO, etc.

The thin film transistor (TFT) is turned on by a scan signal supplied to the scan line (Si). When the thin film transistor (TFT) is turned on, a data signal supplied to the data line (DLi) is supplied to the pixel electrode (Pe) via the thin film transistor (TFT). The liquid crystal functions to control transmissivity according to the voltage applied between the pixel electrode (Pe) and the common electrode (Ce). The liquid crystal transmits light from the corresponding first pixel 40 when the first data signal is supplied to the liquid crystal, and displays a black grey level when the second data signal is supplied to the second pixel 240.

As described above, the organic light emitting display uses the first pixel 40 to display an image with a data related grey level, and uses the second pixel 240, overlapping the first pixel 40, to display a black level. Accordingly, it is possible to display a translucent image with good image quality in the transparent panel 100.

The organic light emitting display according to the present invention and the driving method thereof may be useful to display a black level using the liquid crystal pixel of the liquid crystal panel that is disposed to overlapping the pixels of the transparent panel. Therefore, the organic light emitting display is useful to display a translucent image with good image quality

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. An organic light emitting display, comprising:
a transparent panel, comprising:
a plurality of first pixels, each first pixel including an organic light emitting diode and one or more transistors connected with the organic light emitting diode; and
a semiconductor layer formed of transparent materials;
a liquid crystal panel having a plurality of second pixels, each of the second pixels disposed to overlap one of the first pixels;
a scan driver configured to drive a plurality of scan lines, wherein the scan lines are connected with the first pixels and the second pixels, and corresponding first and second pixels are connected to the same scan line;
a first data driver configured to supply a data signal to first data lines, wherein the first data lines are connected with the first pixels;
a second data driver configured to supply a first data signal or a second data signal to second data lines, wherein the second data lines are connected with the second pixels; and
a timing controller configured to control the scan driver, the first data driver and the second data driver.

2. The organic light emitting display according to claim 1, wherein the transparent panel is located adjacent to the liquid crystal panel.

3. The organic light emitting display according to claim 1, wherein the timing controller is configured to transmit first timing data to the first data driver, and generates second timing data using the first timing data and is configured to transmit the generated second data to the second data driver.

4. The organic light emitting display according to claim 2, wherein the timing controller is configured to supply the second data signal to the second pixel when the black level is displayed in the first pixel, and is configured to supply the first data signal to the second pixel when a grey level other than the black level is displayed in the first pixel.

5. The organic light emitting display according to claim 4, wherein the second pixel transmits the light when the first data signal is supplied to the second pixel and the second pixel displays the black level when the second data signal is supplied to the second pixel.

6. The organic light emitting display according to claim 4, wherein the second pixel is substantially opaque when the second data signal is supplied to the second pixel.

7. The organic light emitting display according to claim 1, wherein each of the first pixels comprises:
an organic light emitting diode; and
a pixel circuit configured to control an electric current in the organic light emitting diode.

8. The organic light emitting display according to claim 1, wherein each of the second pixels comprises:
a thin film transistor connected to one of the scan lines and one of the second data lines;
a storage capacitor connected to the thin film transistor, wherein the storage capacitor is configured to be charged with a voltage corresponding to the first data signal or the second data signal; and
a liquid crystal between a pixel electrode coupled to the thin film transistor and a common electrode, the liquid crystal configured to control the transmission of light therethrough.

9. A method of driving an organic light emitting display comprising a transparent panel having a plurality of first pixels, each of the first pixels including an organic light emitting diode, transistors connected with the organic light emitting diode, and a semiconductor layer formed of transparent materials, the organic light emitting display also comprising a liquid crystal panel having second pixels, each of the second pixels disposed to overlap a corresponding one of the first pixels, the method comprising:
displaying an image by supplying a data signal to the first pixels; and
controlling the second pixels to transmit the light generated in the first pixels or to display a black level.

10. The method of driving an organic light emitting display according to claim 9, wherein the black level is displayed in the second pixel when the corresponding first pixel displays the black level.

11. The method of driving an organic light emitting display according to claim 9, wherein displaying the image and controlling the second pixels each comprising driving the same scan line to which one of the first pixels and one of the second pixels is connected.

12. The method of driving an organic light emitting display according to claim 9, wherein the second pixel transmits the light from the first pixel when a grey level other than the black level is displayed in the first pixel.

13. The method of driving an organic light emitting display according to claim 10, wherein the second pixel is substantially opaque when the second data signal is supplied to the second pixel.

14. An organic light emitting display, comprising:
a transparent panel, comprising a plurality of first pixels, each first pixel including an organic light emitting diode; and
a liquid crystal panel having a plurality of second pixels, each of the second pixels corresponding to one of the first pixels, such that the corresponding pixels substantially overlap,
wherein when a first pixel does not emit light, the corresponding one of the plurality of second pixels is substantially opaque.

15. The organic light emitting display according to claim 14, further comprising a timing controller configured to transmit first timing data to the first pixels, and to generate second timing data using the first timing data and to transmit the generated second timing data to the second pixels.

16. The organic light emitting display according to claim 14, wherein when a first pixel emits light, the corresponding one of the plurality of the second pixels is configured to be substantially transparent.

17. The organic light emitting display according to claim 14, wherein each of the first pixels comprises:
an organic light emitting diode; and
a pixel circuit configured to control an electric current in the organic light emitting diode.

18. The organic light emitting display according to claim 14, wherein each of the second pixels comprises:
a thin film transistor;
a storage capacitor coupled to the thin film transistor, wherein the storage capacitor is configured to be charged with a voltage corresponding to a data signal; and
a liquid crystal between a pixel electrode coupled to the thin film transistor and a common electrode, the liquid crystal configured to control the transmission of light therethrough according to the voltage of the capacitor.

19. The organic light emitting display according to claim 14, wherein each of the first and second pixels is connected to a scan line, and each of the second pixels is connected to the same scan line as the corresponding first pixel.

20. The organic light emitting display according to claim 14, wherein the transparent panel is located adjacent to the liquid crystal panel.
